(19) United States
(12) Patent Application Publication
(10) Pub. No.: US 2003/0070169 A1
(43) Pub. Date: Apr. 10, 2003

(54) Triggered media content in a subscriber television system

(76) Inventors: Robert J. Beyers II, Snellville, GA (US); Warren J. Zyla, Alpharetta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/973,610

(22) Filed: Oct. 9, 2001

(51) Int. Cl. G06F 3/00; H04N 5/445; G06F 13/00; H04N 7/173; H04N 7/16

(52) U.S. Cl. 725/51; 725/112; 725/136

(57) ABSTRACT

In one embodiment of the present invention, a subscriber television system provides a plurality of media content instances to be displayed to a subscriber. The subscriber television system also provides triggers synchronized with instances of media content to enable restrictions on other media content in response to reception of the triggers.

### FIELD OF THE INVENTION

This invention relates in general to subscriber television systems, and more particularly, to the field of media content determination.

### BACKGROUND OF THE INVENTION

Subscriber television systems have advanced rapidly and now provide a large variety of new functionality and services to subscribers. These new services open the door for many new opportunities. A significant portion of these new opportunities involves advanced promotional methods. These services and applications enable new methods to reach and inform potential customers. In implementing enhanced programming, the home communication terminal (“HCT”), otherwise known as the settop box, has become an important computing device for accessing various video services. In addition to supporting traditional analog broadcast video functionality, digital HCTs (or “DHCTs”) now also support an increasing number of two-way digital services such as video-on-demand.

A DHCT is typically connected to a cable or satellite television network and includes hardware and software necessary to provide various services and functionality. Preferably, some of the software executed by a DHCT is downloaded and/or updated via the cable television network. Each DHCT also typically includes a processor, communication components and memory, and is connected to a television or other display device, such as a personal computer. While many conventional DHCTs are stand-alone devices that are externally connected to a television, a DHCT and/or its functionality may be integrated into a television or personal computer, as will be appreciated by those of ordinary skill in the art.

The various services and functionality provided by the DHCT enable the simultaneous presentation of various services and functionalities to the subscriber. While the simultaneous display of numerous services and functionalities creates many new promotional opportunities, it also creates significant problems regarding traditional promotional methods. These problems range from promotional conflicts to diminished visibility. In addition, the new functionalities may decrease the effectiveness and exposure traditionally received by many promotional measures. Thus, a heretofore unaddressed need exists in the industry to address the aforementioned deficiencies or other inadequacies.

### BRIEF DESCRIPTION OF THE DRAWINGS

The accompanying drawings, incorporated in and forming a part of the specification, illustrate several aspects of the preferred embodiments of the present invention, and together with the description serve to explain the principles of the preferred embodiments of the invention. The components in the drawings are not necessarily to scale, emphasis instead being placed upon clearly illustrating the principles of the preferred embodiments of the present invention. Moreover, in the drawings, like reference numerals designate corresponding parts throughout the several views. The reference numbers in the drawings have at least three digits with the two rightmost digits being reference numbers within a figure. The digits to the left of those digits are the number of the figure in which the item identified by the reference number first appears. For example, an item with reference number 209 first appears in FIG. 2. In the drawings:

FIG. 1 is a block diagram of a high level view of the architecture of the subscriber television system (STS) in accordance with one embodiment of the present invention.

FIG. 2 is a block diagram illustrating a headend of the STS of FIG. 1 in accordance with one embodiment of the present invention.

FIG. 3 is a block diagram illustrating a client device of the STS of FIG. 1 in accordance with one embodiment of the present invention.

FIG. 4 is a block diagram illustrating a client command device of the STS of FIG. 1 in accordance with one embodiment of the present invention.

FIG. 5 is a diagram presenting a screen display provided by the STS of FIG. 1 in accordance with one embodiment of the present invention.

FIG. 6 is a diagram presenting a screen display of an example In View application provided by the STS of FIG. 1 in accordance with one embodiment of the present invention.

FIG. 7 is a diagram presenting a screen display of an example video on demand application provided by the STS of FIG. 1 in accordance with one embodiment of the present invention.

FIG. 8A is a diagram of an example transport stream provided by the STS of FIG. 1 in accordance with one embodiment of the present invention.

FIG. 8B is a diagram of an example transport stream provided by the STS of FIG. 1 in accordance with one embodiment of the present invention.

FIG. 9 is diagram depicting an example content restrictions storage method used in the STS of FIG. 1 in accordance with one embodiment of the present invention.

FIG. 10 is a flowchart of the process of determining the actions by the content control module when a trigger PDU is received in accordance with one embodiment of the present invention.

FIG. 11 is a flowchart of the process of determining the actions by the administrative content control module 170 (FIG. 1) when a trigger PDU is received from a central broadcast location in accordance with one embodiment of the present invention.

FIG. 12 is a flowchart of the process of determining the actions when a television studio makes certain content restriction requests from the STS of FIG. 1 in accordance with one embodiment of the present invention.

FIG. 13 is a diagram depicting a screen display in accordance with one embodiment of the present invention.

### DETAILED DESCRIPTION OF THE PREFERRED EMBODIMENTS

The present invention may, in one embodiment, be implemented as part of a subscriber television system (STS). The following terms are used in the following manner with regard to the preferred embodiment of the present invention, but other uses would be understood by those reasonably skilled in the art of the present invention. The term media content is generally used herein to describe instances of any type of television program, movie, advertisement, promotion, commercial, web page, image, video, audio, etc. that can be presented to a subscriber, wherein an instance is generally understood to represent a single unit of media content, such as a single television program, movie, web page, advertisement, etc. A restriction includes a division of possible actions into a group of acceptable actions and/or a group of unacceptable actions, thereby enabling the group of acceptable actions, with actions including displaying certain media content. The term priority event is used to describe any occurrence generating special consideration by the system or method described herein. A walled garden is used herein to describe an environment that confines a subscriber's access to a limited set of data, usually, but not limited to being, in the form of web pages. An administrator is typically one who controls the system or method described herein, such as, for example, a system operator located at a system headend. A subscriber is typically a customer or local user of a client device in the system or method described herein. A protocol data unit (PDU) is any arrangement of data in accordance with a given protocol, examples including, among others, a datagram, a frame, a packet, a cell, or a bit in a given protocol. The term company is used herein to define any organization or entity such as, for example, a partnership or a corporation. The term funding entity is used herein to describe any entity, such as a company, that pays for a certain service or product.

Reference will now be made in detail to the description of the preferred embodiments of the invention as illustrated in the drawings. While the various embodiments of the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims. All examples, embodiments, implementations, etc., are understood to be non-limiting and among others.

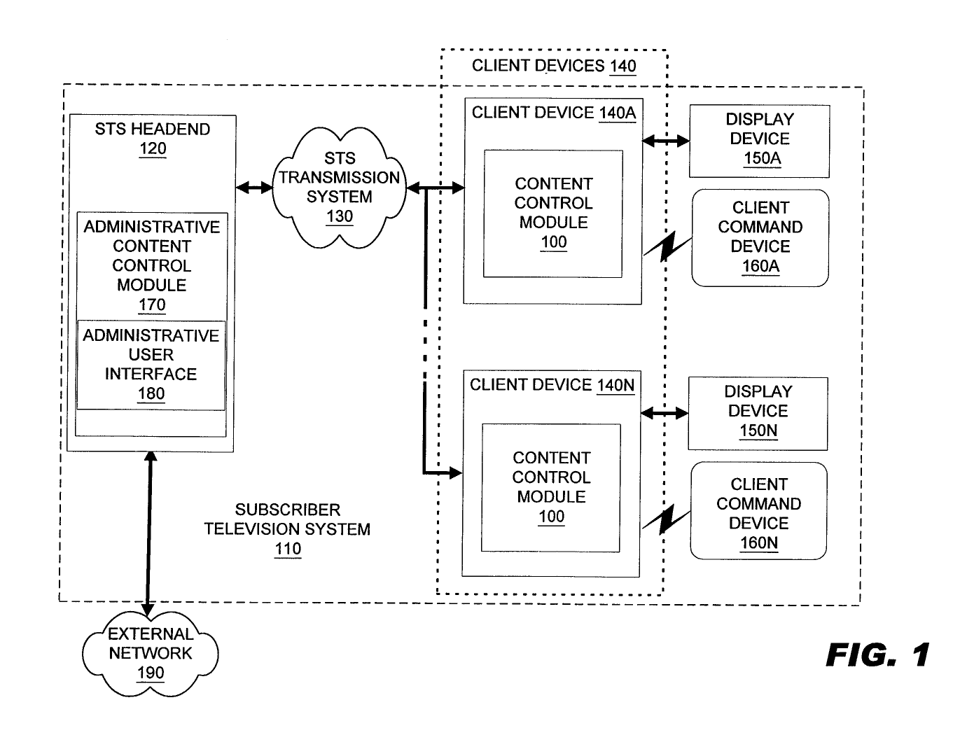

FIG. 1 depicts the general architecture of a subscriber television system 110 in which a subscriber television system (STS) headend 120 provides media content over an STS transmission system 130 to numerous client devices 140. Each client device, such as client device 140A, interprets information received from the STS headend 120 via the STS transmission system 130 such that it can be provided to the display device 150A and then presented to the subscriber. The client command device 160A enables the subscriber to provide commands to the client device 140A. With the client command device 160 A, the subscriber can enter input to effect the presentation that is to be displayed on the display device 150A.

The display device 150A can be any system that enables a user to experience a session provided by the client device 140A. The display device 150A can be, for example but not limited to, a television, a computer monitor, a projection unit, or a simulator providing visual and audible stimulation. The display device 150A processes information from the client device 140A. The display device 150A processes the information such that it can be viewed, heard or otherwise presented to the senses of the subscriber. The client command device 160A can be any entity that relays user input to the client device 140A. Examples of the client command device 160A include, among others, a remote control, a wired or wireless keyboard, a mouse, and a voice command device. The commands given by the client command device 160A dictate, among other things, the execution of certain actions within the client device 140A. With the use of the client command device 160A and the display device 150A, the user can experience and interact with the subscriber television system 110. In an alternate embodiment of the system depicted in FIG. 1, the client device 140A and the display device 150A can be implemented in the same device. In addition, the client command device 160A could be incorporated into an entity containing the client device 140A and/or the display device 150A.

The client command device 160A preferably allows the subscriber to utilize the functionality of the client device 140A. Using the client command device 160A, the subscriber can, among other things, navigate and scroll through media content guides and make selections. The subscriber television system 110 enables the subscriber to interact with the system with regard to particular services. The subscriber television system 110 provides programming that is accessible with interactive user inputs such as, for example but not limited to, broadcast pay-per view programming, and broadcast near video on demand (NVOD). Furthermore, the subscriber television system 110 provides on demand programming that is also accessible with interactive user input such as, for example but not limited to, video on demand (VOD), internet applications, and/or interactive media guides (IMG). The subscriber may navigate different guides, information, and programs to gain information and to learn about available items. If the subscriber discovers an item of interest that requires or allows a purchase, then that subscriber may enter and complete a transaction for purchasing the item of interest. With access to varied applications, including access to the internet, it is possible for a subscriber to complete purchases for many kinds of goods and services in addition to media content services.

In one embodiment of the current invention, the content control module 100 is enabled to control the media content that is displayed to a subscriber. The content control module 100 is illustrated in FIG. 1 as an entity within client device 140A. It should be clear to one of ordinary skill in the art that the content control module 100 could be implemented in various ways. Examples include, among others, an independent unit, a logic module within the client command device 160A, a software logic module within the STS headend 120, a module within the STS transmission system 130, or a logic module within any device in the subscriber television system 110. Furthermore, a distributive content control module 100 could be implemented in various ways such as, for example but not limited to, part in the STS headend 120 and part in the client device 140A. In one implementation, the content control module 100 is not as depicted in FIG. 1, but is a module within an application module on the client device 140A. Therefore, there could be numerous content control modules 100 in the client device 140A, each one being a sub-component of a larger application.

In one embodiment of the present invention, the administrator, or system operator, of the subscriber television system 110 can designate restrictions upon the display of certain media content by administering the subscriber television system 110 through the administrative content control module 170. In one implementation of this embodiment, the administrative user interface 180 provides the administrator with an interface from which the administrator can create and manipulate the content restrictions that are provided to the content control module 100. In an alternate implementation, the administrator can configure the administrative content control module 170 to be configurable by a source outside the subscriber television system 110, examples including, among others, a source in the external network 190. In one implementation, the administrator can define content restrictions to be assigned to designated regions of the network and even to a particular one of the client devices 140.

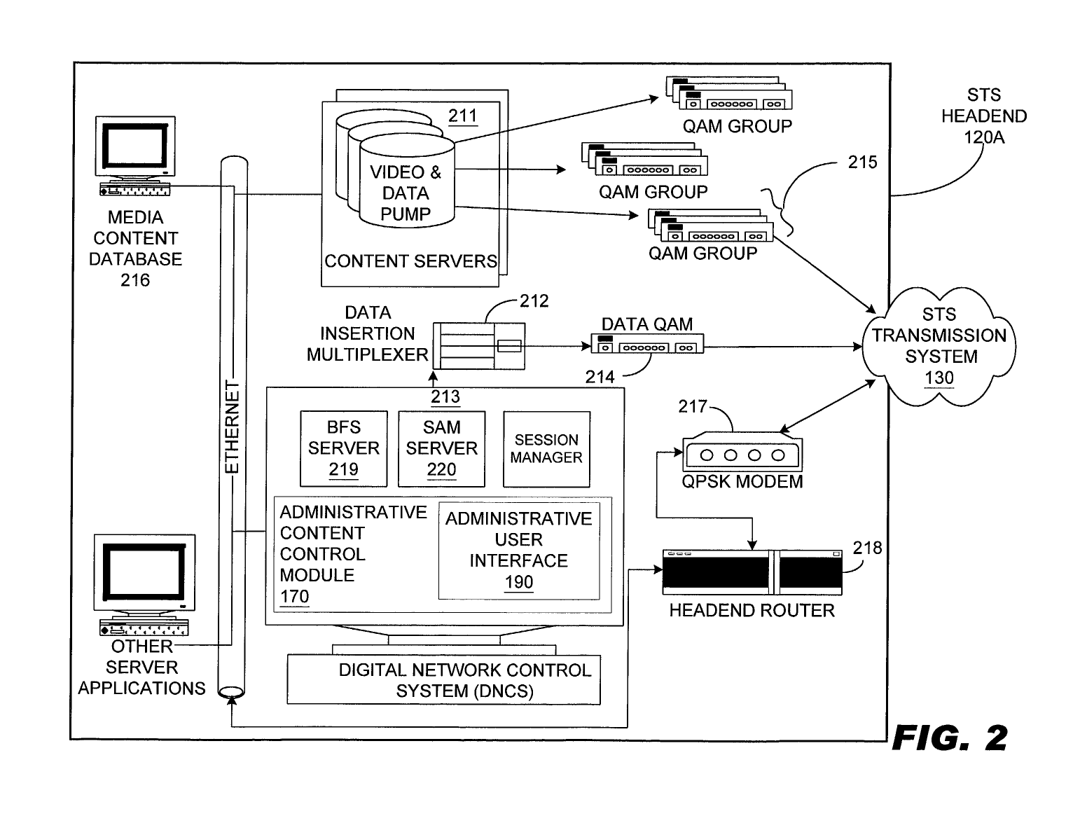

FIG. 2 depicts an implementation of the STS headend 120A in accordance with one embodiment of the present invention. STS headend 120A is configured to provide numerous functionalities to the client devices 140 (FIG. 1). In a non-limiting example, the subscriber television system 110 (FIG. 1) is controlled from the headend by a computer shown as the digital network control system (DNCS) 213. The DNCS 213 includes the administrative content control module 170 that is responsible for reserving and configuring system resources needed to provide configuration and service data to the content control module 100 (FIG. 1). In an alternate implementation, the administrative content control module 170 exists separate from the DNCS 213.

The DNCS 213 provides management, monitoring, and control of the network's elements and broadcast services provided to users. The DNCS 213 controls the content servers 211 that drive the video & data pumps providing media content to the STS transmission system 130 as well as the infrastructure for broadcast media services such as PPV and NVOD. In one implementation, the DNCS 213 uses a data insertion multiplexer 212 and a data QAM 214 to insert in-band broadcast file system (BFS) data in to an MPEG-2 transport stream that is broadcast over the STS transmission system 130 to the client devices 140 (FIG. 1). The content servers 211 house the video & data pumps that supply media content to the client devices 140 (FIG. 1) through the QAM group 215. The QPSK modem 217 can be utilized to transport the out-of-band datagram traffic between the STS headend 120A and the client devices 140 (FIG. 1). Through the use of the control and management devices in the STS headend 120A, an administrator can control the services provided by the subscriber television system 110 (FIG. 1).

The media content database 216 is an alternate storage location for various types of media content for the subscriber television system 110 (FIG. 1). In some implementations, the client devices 140 (FIG. 1) can access the media content database 216 to retrieve necessary media content, examples including, but not limited to, images, video, commercials, and audio files. The media content database 216 can be a separate device, as depicted in FIG. 2, or a portion of another device in the system such as, for example, the DNCS 213.

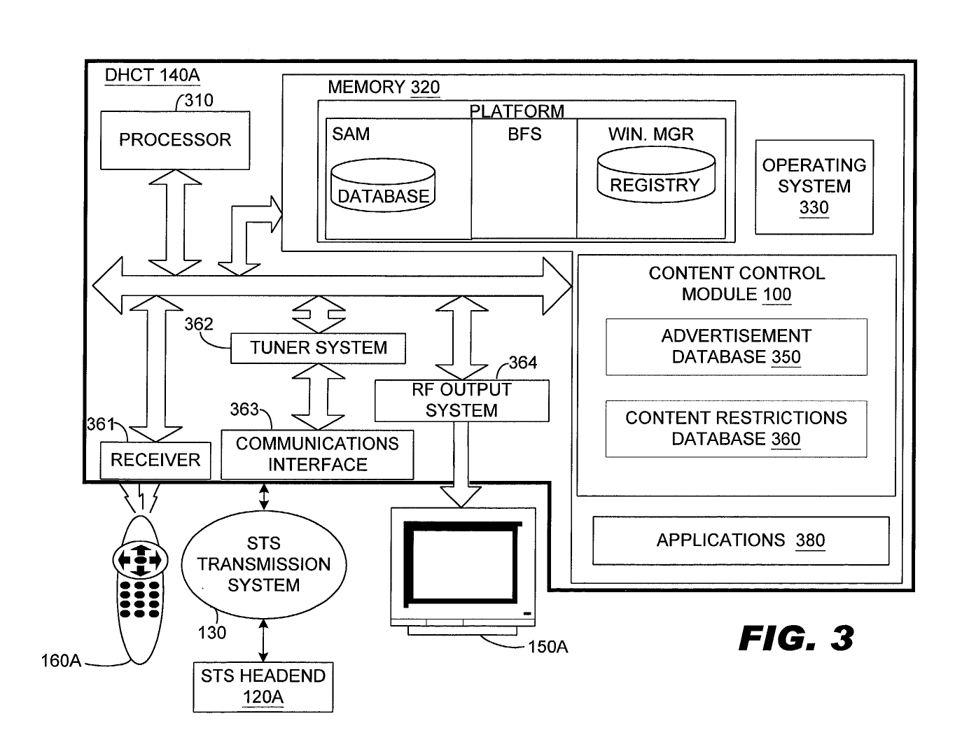

A service application manager (SAM) server 220 is a server component of a client-server pair of components, with the client component being located at the digital home communications terminal (DHCT) 140A (FIG. 3). Together, the client-server SAM components provide a system in which the user can access services, which are identified by an application to run and a parameter, such as particular data content, specific to that service. The client-server SAM components also manage the life cycle of the applications on the system, including the definition, activation, and suspension of services they provide and the downloading of the applications into the DHCT 140A (FIG. 3) as necessary. With the use of SAM Server 220 and the client-server SAM components, a subscriber's DHCT 140A (FIG. 3) is able to access services such as NVOD, video on demand, pay-per view, electronic program guides (EPG), browsing (such as through a service commonly known as InView), digital music, and media on demand (MOD), among many others, including traditional non-traditional services.

Applications on both the STS headend 120A and the DHCT 140A (FIG. 3) can access the data stored in a broadcast file system (BFS) Server 219 in a somewhat similar manner to a file system found on typical operating systems. The BFS server 219 is a part of a broadcast file system that has a counterpart BFS client module in a DHCT 140A (FIG. 3) connected to the STS transmission system 130. The BFS server 219 repeatedly sends data for applications on a data carousel over a period of time in cyclical repeated fashion so that a DHCT 140A (FIG. 3) may read any particular data file or parts thereof, and receive it and store it in memory 320 (FIG. 3). Reception of such data may be a result of a subscriber request or instigated by one or more application or internal processes in DHCT 140A (FIG. 3). Data, such as content restrictions and trigger Protocol Data Units (PDU)s, is accessed from memory 320 (FIG. 3) and if necessary converted to a displayable format. The STS headend 120A depicted in FIG. 2 is merely provided as an example implementation. The STS headend 120A could be implemented in many other ways without many of the components depicted in FIG. 2 and/or with many more additional components.

FIG. 3 is a diagram depicting an implementation of one of the client devices 140 (FIG. 1) in accordance with one embodiment of the current invention. The device depicted in FIG. 3 is DHCT 140A, a specific implementation of one of the client devices 140 (FIG. 1). The DHCT 140A is typically situated within a residence or business of a user. It may be integrated into a device that has a display unit, such as a television set, or it may be a stand-alone unit that couples to an external display. The DHCT 140A includes a processor 310 for controlling operations of the DHCT 140A, a video output port such as an RF output system 364 for driving the display device 150A, and tuner system 362 for tuning into a particular television channel to be displayed and for sending and receiving various types of data from the STS headend 120A. The tuner system 362 includes, in one implementation, an out-of-band tuner for bi-directional Quadrature Phase Shift Keying (QPSK) data communication and a Quadrature Amplitude Modulation (QAM) tuner for receiving television signals. Additionally, DHCT 140A includes a receiver for receiving externally generated information, such as user input from a client command device 160A. In this implementation shown in FIG. 3, the client command device 160A is a remote control. Other types of client command devices such as a keyboard, a mouse, or a voice command device may also provide the user inputs. The DHCT 140A may also include one or more wireless or wired communication interfaces, also called ports, for receiving and/or transmitting data to other devices.

Memory 320, such as non-volatile (i.e., SRAM or FLASH memory) and dynamic random access memory (DRAM), is coupled to the processor 310 and stores operation parameters, such as commands that are recognized by the processor 310. The most basic functionality of the DHCT 140A is provided by an operating system 330 that operates in memory 320. One or more programmed software applications, herein referred to as applications 380, are executed by utilizing the computing resources in the DHCT 140A. The applications 380 stored in memory 320 are executed by processor 310 (e.g., a central processing unit or digital signal processor) under the auspices of the operating system 330. Data required as input by the applications 380 is stored in memory 320 and read by processor 310 from memory 320 as need be during the course of application program execution. Input data may be data stored in memory 320 by a secondary application or other source, either internal or external to the DHCT 140A, or may have been created with the application at the time it was generated as an application. Data may be received via any of the communication ports of the DHCT 140A, from the STS headend 120A via the DHCT's network interface (i.e., the QAM or out-of-band tuners) or as user input via receiver 361. In a non-limiting example, data in files that are broadcast from BFS server 219 can be received via the QAM and/or out-of-band tuners. Data generated by an application is stored in memory 320 by processor 310 during the course of application program execution.

In accordance with the embodiment depicted in FIG. 3, the content control module 100 is enabled to execute in accordance with the aforementioned interactions with, among other things, the memory 320, the processor 310, and the operating system 330. The content control module 100 executes, on the processor 310, in accordance with the commands received through the communications interface 363 provided by the STS headend 120A. In addition to the received commands, the content control module 100 can also require that certain application specific stored information be executed by the processor 310. As previously mentioned, the content control module can be a sub-component module within one or more applications 380 in the DHCT 140A. In a non-limiting example, the content control module 100 could be a module within a browser application, such as a browser application known as InView, among others.

An advertisement database 350 depicted in FIG. 3 can be utilized to store advertisement data, such as, among others, image, video, or sound files. Herein, database will refer to a database, structured data, or other data structures well known to those of ordinary skill in the art. As a non-limiting example, subscriber database 350 includes images of logos and products of numerous different companies.

A content restrictions database 360 depicted in FIG. 3 allows for storage of information concerning specific content restrictions to be implemented by the content control module 100. In one implementation, the content restrictions database 360 could hold a table of unique bit sequences and associated paths to desired media content. In a non-limiting example, the content restrictions database 360 could contain a table, where the table holds a list of titles of commercials and their associated advertisement banner titles. Alternatively, the table could hold a list of commercials and advertisement banners that should not be associated with each individual commercial. In another non-limiting example, the table would hold lists of both associated and dissociated advertisement banners for each individual commercial. It should be apparent to one of ordinary skill in the art that the content restrictions database 360 could be implemented in a variety of different ways to accomplish the requirements of various implementations, some of which will be described further below.

The DHCT 140A depicted in FIG. 3 is merely provided as an example implementation of one of the client devices 140 (FIG. 1). The client devices 140 (FIG. 1) could be implemented in many other ways without many of the components depicted in FIG. 3 and with many more additional components.

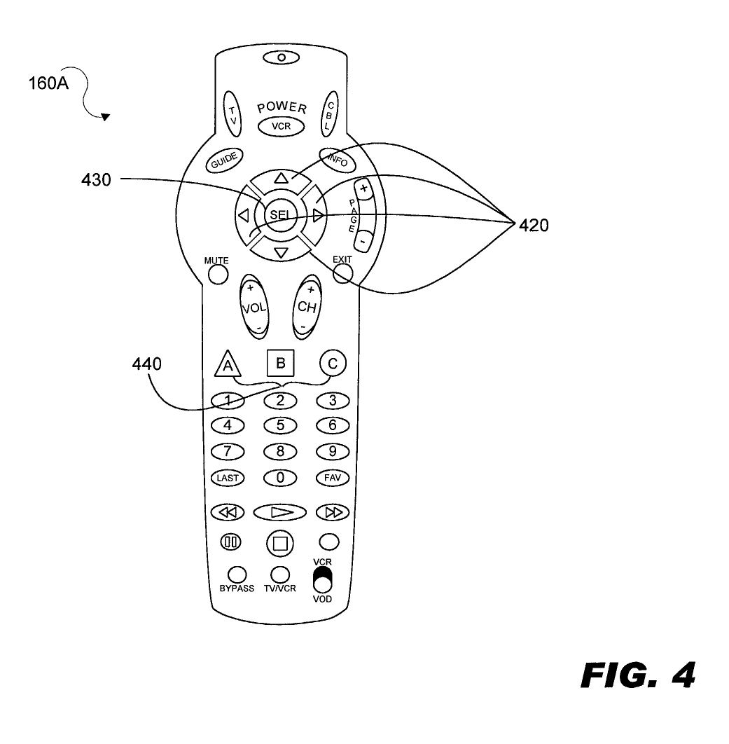

FIG. 4 is a diagram depicting an example of a client command device 160A in accordance with one embodiment of the current invention. Certain keys on the client command device 160A are used to request execution of particular functions by the DHCT 140A (FIG. 3). In one implementation, the navigation pad 420 allows the subscriber to browse user interface screens displayed by the DHCT 140A (FIG. 3). In a non-limiting example, a free floating arrow, similar to a conventional personal computer mouse pointer, could be displayed and controlled by the navigation pad 420 on the client command device 160A. In another example, the arrows on the navigation pad 420 could enable the subscriber to cycle through selectable elements. In one implementation, pressing the right arrow on the navigation pad 420 causes the next selectable element on the screen to be highlighted or come into focus. When the element is shown as highlighted or in focus, then that element is currently active. In most implementations, the subscriber can perform a function on an element when it is active. In one implementation, when the subscriber strikes the select button 430 key, then the active element is selected. The select button 430 can be used for a variety of functions, examples including, among others, clicking on links to other interfaces or requesting items. In addition to the select button 430, there are other keys on the client command device 160A termed function keys 440. The function keys are used, among other things, for performing functions on non-highlighted elements. In one implementation, the “C” button of the function keys 440 can be pressed to exit from a particular screen. In a non-limiting example, the client command device 160A could be a standard TV remote control.

In some of the implementations described below, reference is made to the simultaneous display of varied media content. It should be apparent to one of ordinary skill in the art that this simultaneous display of media content may only occur when the display provided by the subscriber television system 110 (FIG. 1) has the ability to display more than one media content instance. In a non-limiting example, if a subscriber is viewing a traditional full screen display of a TV channel, then executions by the content control module 100 (FIG. 1) may not apply if no secondary media content is to be displayed.

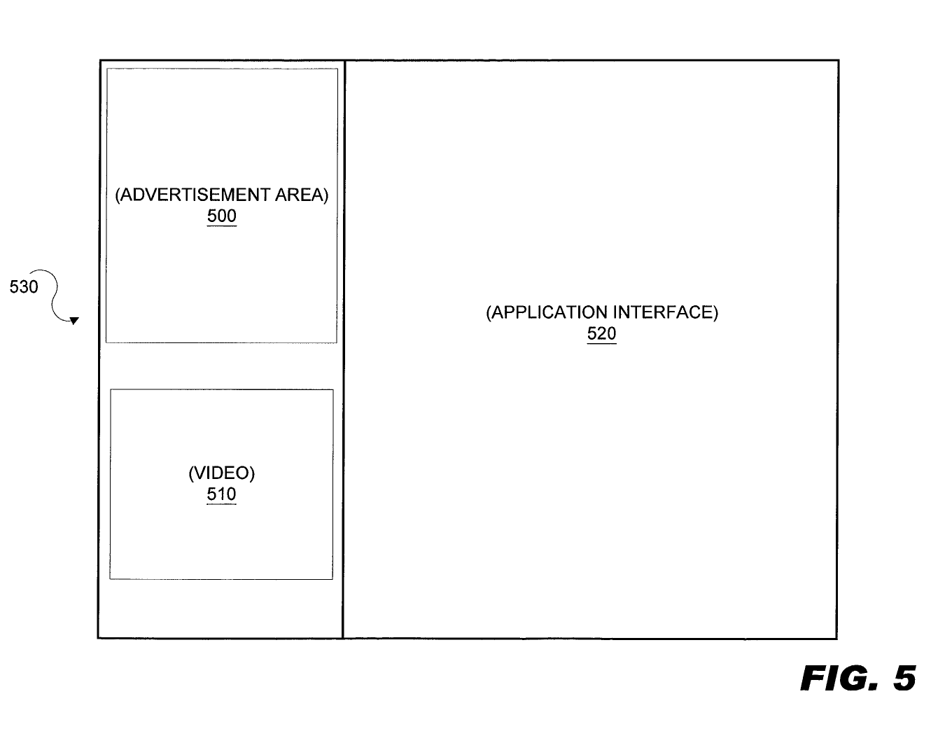

FIG. 5 is a diagram presenting a screen display in accordance with one embodiment of the present invention. In one implementation, the screen display 530 is displayed to the subscriber after the subscriber has chosen to use an application while watching a video stream. The implementation depicted in screen display 530 shows the application interface 520 occupying a majority of the total screen. This application interface 520 could be an interface to a variety of different applications provided by the subscriber television system 110 (FIG. 1) or an external source. Examples of application interface 520 include, among others, a web interface to an intranet or the internet, a gaming interface to video games, a programming guide, or an interface to alternate streams of audio of video. The other portion of the screen display 530 contains, among others, an advertisement area 500 and a video area 510. In one implementation, the video 510 preferably displays the video stream the user is currently watching and can show any video stream, such as, among others, a live TV broadcast, a video on demand, a pay-per view event, or an NVOD. The advertisement area 500 could be used to display any form of media content, examples including, among others, images and video. In the implementation depicted in FIG. 5, the content control module 100 (FIG. 1) restricts the content displayed in the advertisement area 500. The content displayed in the advertisement area 500 is limited by content restrictions, and the advertisement area 500 displays a reduced set of media content instances during the occurrence of priority events.

In one implementation, the content control module 100 (FIG. 1) provides content restrictions that require the media content instances displayed in the advertisement area 500 to be associated with one or more particular companies or sources. In addition, the content control module 100 (FIG. 1) can implement the content restrictions to be active only during the occurrence of priority events. In a non-limiting example, a priority event occurs when a defined media content instance is displayed in the video area 510 of the screen display 530. In a non-limiting example of a the subscriber watching a live TV broadcast of a baseball game, when the baseball game live TV broadcast cuts to a commercial, the subscriber decides to activate an application. In doing so, the subscriber is presented with the screen display 530 depicted in FIG. 5. The application interface 520 is shown in the right hand portion of the subscriber's screen display 530, and the baseball game live TV broadcast video stream is reduced and displayed in the video area 510 of the screen display 530. A commercial in the baseball game live TV broadcast stream displayed in the video area 510 of the screen display 530 may be for Company X, and the display of the commercial for Company X is an example of a priority event in which the content control module 100 (FIG. 1) dictates what media content is displayed in advertisement area 500. The content restrictions associated with this priority event, as provided by the content control module 100 (FIG. 1), may require the media content displayed in advertisement area 500 to be an image of Company X's logo. The content control module 100 further may require that this image of Company X's logo be displayed for the fill duration of Company X's commercial broadcast. Thus, the content control module 100 (FIG. 1) can require the reduced display of Company X's commercial to be accompanied by a simultaneous display of Company X's logo in the advertisement area 500 portion of the screen display 530.

The above example is only one implementation of the numerous different ways in which the content control module 100 (FIG. 1) can control the display of media content provided by one of the client devices 140 (FIG. 1) in the subscriber television system 110 (FIG. 1). It should be apparent to one of ordinary skill in the art that the implementations provided are only examples of ways in which the different embodiments of the present invention can be implemented.

In one embodiment, the aforementioned content restrictions provided by the content control module 100 could be restrictions that require the inclusion of certain media content and/or restrictions that require the exclusion of certain media content. Therefore, in a non-limiting example, inclusive content restrictions would require the display of one particular media content instance (of a group, in some implementations) in the advertisement area 500 when a corresponding media instanc, such as a particular commercial, is displayed in the video area 510 of the screen display 530. Exclusive content restrictions might require, in one implementation, that certain media content instances not be displayed in the advertisement area 500 when corresponding commercial media is displayed in the video area 510 of the screen display 530. The inclusive and exclusive content restrictions may prove advantageous for various different circumstances. In a non-limiting example, Company X may desire to purchase commercial time in a TV broadcast and would like their commercials to be supported by congruent banner advertisements or at least not be conflicted with competitors' advertisements. In this non-limiting example, the content control module 100 (FIG. 1) would enable the administrator of the subscriber television system 110 (FIG. 1) to provide the desired function for Company X. Thus, the content control module 100 (FIG. 1) could be configured to require the media content displayed in advertisement area 500 to be related to Company X, or at least not related to Company X's competitors, when Company X's commercials are displayed in the video area 510.

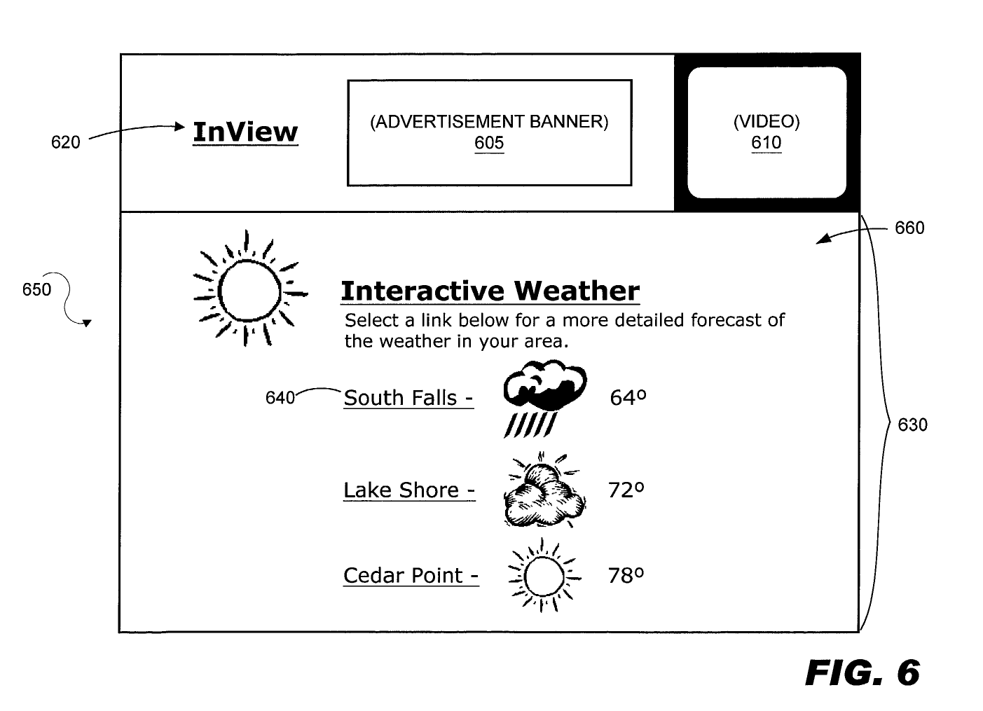

FIG. 6 is a diagram presenting a screen display in accordance with one embodiment of the present invention. In one implementation, the screen display 650 is the screen display for a browsing application, as indicated by the application title indicator 620, showing InView. Of course, other browser applications and non-browser applications are within the scope of the present invention. In the embodiment depicted in FIG. 6, the InView browsing application allows the subscriber to view numerous information screens. In this example, the information screens are often, but not limited to, web pages. In one implementation, these web pages can be provided from sources within the subscriber television system 110 (FIG. 1), creating a walled garden environment. In other implementations, these web pages can be provided by sources external to the subscriber television system 110 (FIG. 1), such as from sources on the internet. In one implementation, the subscriber can access the InView application by pressing an appropriate function key 440 (FIG. 4) or by selecting an InView option while watching a TV broadcast channel. When the screen display 650 for the InView application is displayed, the TV broadcast channel is reduced and displayed in the video area 610 of the screen display 650. An information screen 630 is shown in FIG. 6 as an Interactive Weather page 660 where the subscriber can find out detailed current weather information. In one implementation, the subscriber can access another information screen by selecting a link to a more detailed forecast for South Falls 640 by using arrow keys 420 (FIG. 4) to move a free-floating pointer or to toggle through options with highlighting and pressing the select button 430 (FIG. 4) on the client command device 160A (FIG. 4). While the subscriber navigates numerous different information screens 630, the TV broadcast channel is displayed in a video area 610 of the screen display 650. The content control module 100 (FIG. 1) is enabled to synchronize the display in the video area 610 of the screen display 650 with the display in an advertisement banner 605 of the screen display 650. In one implementation, the video area 610 shows a typical TV broadcast channel with programs and commercials. The content control module 100 (FIG. 1) can be configured to recognize the display of particular commercials in the video area 610 as priority events. Thereby, in this implementation, a priority event is the display of particular commercial in the TV broadcast channel. Associated with a particular commercial's priority event are specific content restrictions. In an non-limiting example, a commercial for Company A might be associated with inclusive content restrictions requiring simultaneous display of a media content instance, such as a logo banner, among others, for Company A in the advertisement banner 605 of the screen display 650. Therefore, in one implementation, when Company A's commercial airs on the TV broadcast channel being displayed in video area 610, a logo for Company A would be displayed in advertisement banner 605.

In an alternate non-limiting example, only exclusive content restrictions are present. The exclusive content restrictions might only require that the media content displayed in the advertisement banner portion not be that of a competitor to Company A when Company A's commercials are displayed. In this example, if Company A's competitor had media content being displayed in the advertisement banner portion when Company A's commercials were being displayed, then the content control module 100 (FIG. 1) would require a change in the advertisement banner 605 to a non-competing media content instance.

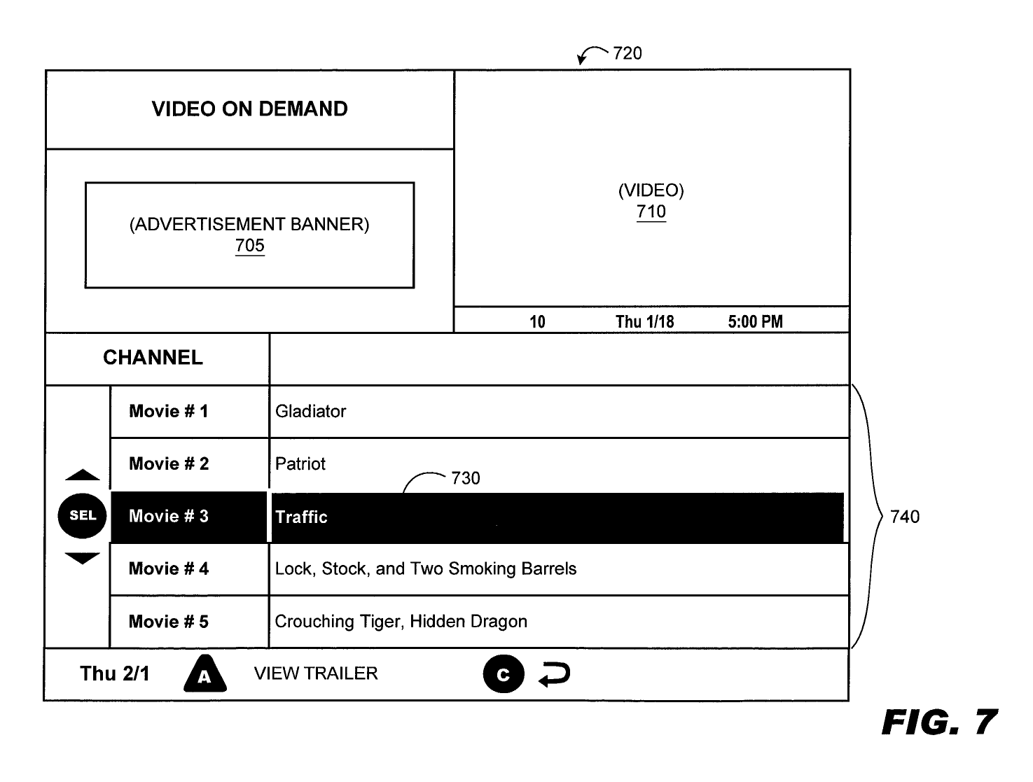

FIG. 7 is a diagram presenting a screen display 720 in accordance with one embodiment of the present invention. In one implementation, the screen display 720 is the screen display for a video on demand application, which is preferably part of many interactive services provided by the subscriber television system 110 (FIG. 1). The video on demand application can be accessed in a variety of different ways, examples including, but not limited to, a selection key on the remote or from a general settings menu. In one implementation, the video on demand application, allows the subscriber to browse a list of available movies 740 that can be selected for individual viewing. In a non-limiting example, the video area 710 of the screen display 720 may show a currently-viewed TV broadcast channel. In a manner similar to the implementation described above in relation to FIG. 6, the content control module 100 (FIG. 1) could limit the display in the advertisement banner 705 portion in accordance with priority events in the video area 710 of the screen display 720.

In another implementation, the video portion of the screen display 720 is configured to display trailers of the movies available from the video on demand application. In this implementation, the content control module 100 (FIG. 1) is configured to restrict the display of media content in the advertisement banner 705 portion of the screen display 720. The content control module 100 (FIG. 1) utilizes content restrictions specific to the video on demand application. In a non-limiting example, the content control module 100 (FIG. 1) requires that the display of a trailer for Movie Q in the video area 710 of the screen display be accompanied by the display of media content pertaining to Movie Q in the advertisement banner 705 portion of the screen display 720. The media content pertaining to Movie Q could be, for example but not limited to, the title of the Movie Q, a logo for the Movie Q, or an advertisement for a product associated with the Movie Q. Alternate implementations might allow for exclusive content restrictions in which the advertisement banner 705 could not display media content from a movie corporation in competition with the movie corporation whose film is being previewed in the trailer playing in the video area 710 of the screen display 720.

As previously mentioned, the video on demand application allows a subscriber to select a movie for individual viewing. The content control module 100 (FIG. 1) could not only restrict the display of media content in the video on demand programming guide screen, but it could also restrict the display of media content during the individual viewing of a movie. In a non-limiting example, when the subscriber purchases a video on demand title, promotional media content is shown before, during, and after the individual viewing. In one implementation, the content control module 100 (FIG. 1) could be configured to determine what promotional media content is shown in association with the individual viewing. In a non-limiting example, the content control module 100 (FIG. 1) might require the display of previews for other movies funded by the company who provided the movie title requested or the exclusion of previews for competitors. In an alternate example, the content control module 100 (FIG. 1) might require the display of commercials for certain sponsoring companies.

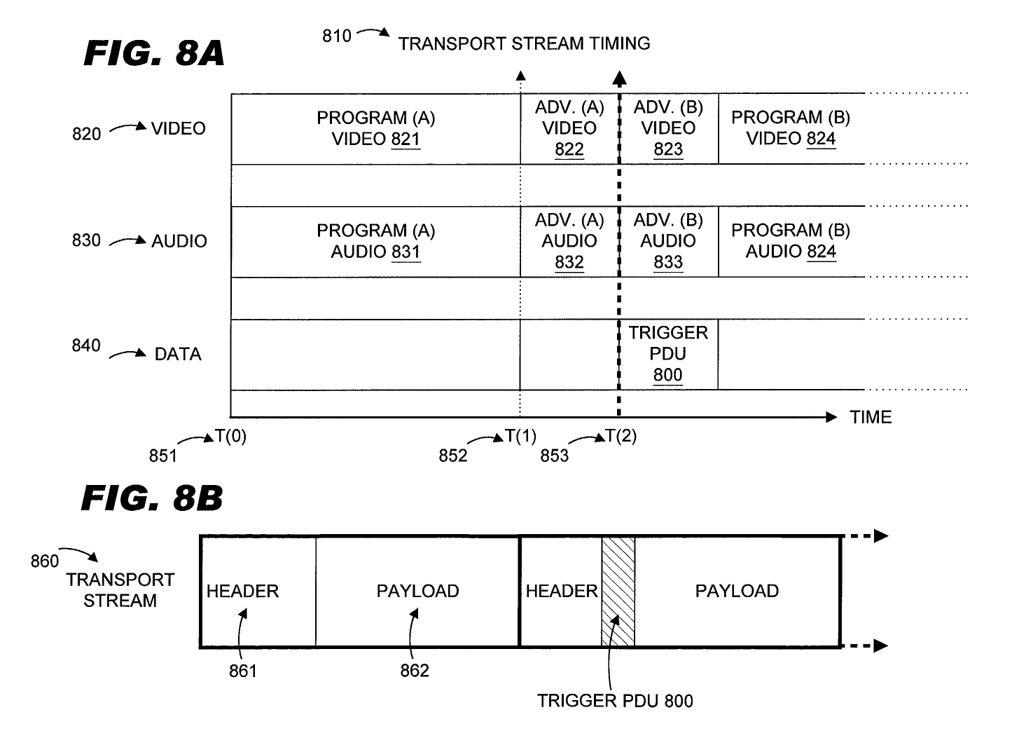

FIG. 8A is diagram depicting an example transport stream. In the example embodiment depicted in FIG. 8A, the example transport stream has three elemental subcomponents: a video stream 820, an audio stream 830, and a data stream 840. The transport stream depicted in FIG. 8A could be implemented in a variety of different transport protocols, an example including, among others, an MPEG-2 transport stream. It should be apparent to one of ordinary skill in the art that the format of the diagram of FIG. 8A is for illustrative purposes and does not indicate the actual transport stream, which could be implemented as one stream with numerous multiplexed sub-components. The diagram of FIG. 8A illustrates one method by which the content control features may be implemented. In the first time instant, T(0) 85 1, the video stream 820 provides data for program A video 821 and the audio stream 830 provides the associated audio data for program A audio 831. At time instant T(1) 852, the video stream 820 begins providing the video data for an advertisement (adv.), adv. A video 822, and the audio stream 830 provides the associated audio data, adv. A audio 832. It is at time instant T(2) 853, that the content control module 100 (FIG. 1) receives an indication of a priority event. As discussed above, a priority event is any occurrence where the content control module 100 (FIG. 1) may restrict the display of media content. At time instant T(2) 853, the data stream 840 provides a trigger protocol data unit (PDU) 800. In one implementation, the trigger PDU 800 indicates that a priority event is occurring and that the content control module 100 (FIG. 1) should execute the appropriate content restrictions. In the example depicted in FIG. 8A, the priority event constitutes the reception and subsequent display of advertisement (B), adv. B video 823 and adv. B audio 833. In a non-limiting example, the trigger PDU 800 indicates to the content control module 100 (FIG. 1) that advertisement (B) is being displayed. Next, the content control module 100 (FIG. 1) determines the content restrictions associated with advertisement (B). The content control module 100 (FIG. 1) then enacts the content restrictions by restricting the media content that is displayed to the subscriber. In some implementations, the trigger PDU 800 may cause the content control module 100 (FIG. 1) to activate content restrictions for advertisement (B) only while advertisement (B) is being displayed. In alternate implementations, the content restrictions may remain active for a certain period of time or until another trigger PDU 800 is received in the data stream 840, among others.

In one non-limiting example, the content control module 100 (FIG. 1) might require an advertisement banner to display a media content instance related to the company funding advertisement (B). In another non-limiting example, the content control module 100 (FIG. 1) might implement certain exclusive content restrictions for advertisement (B) that ensure no media content is displayed for companies that compete with the company funding advertisement (B).

The trigger PDU 800 can be implemented to incorporate many different features. In the most simplistic implementation, the trigger PDU 800 is simply a flag that indicates a priority event to the content control module 100 (FIG. 1). This would require the content control module 100 (FIG. 1) to monitor the data stream for the trigger PDU 800 and then independently determine the details of the priority event and the necessary actions based on given content restrictions.

In another implementation, the trigger PDU 800 could contain information about the details of the priority event and the necessary content restrictions. In a non-limiting example of this implementation, the trigger PDU 800 would not only provide a flag to the content control module 100 (FIG. 1) but also indicate what commercial is currently being received and what media content should be displayed in the advertisement banner. In a non-limiting example, the content restriction contained in the trigger PDU 800 would consist of a path to a file located in the client device 140A (FIG. 1) or in the STS Headend 120 (FIG. 1). Therefore, the content restriction would designate a particular file to be accessed for display in the advertisement banner area during the occurrence of the priority event.

In yet another implementation, the trigger PDU 800 provides a unique bit sequence to the content control module 100 (FIG. 1). This unique bit sequence not only serves as an indication of a priority event but also designates a particular media content item to be displayed during this priority event. In a non-limiting example, the trigger PDU 800 would be the value 7. The content control module 100 (FIG. 1) takes this trigger PDU 800 value 7 and looks it up on a table stored in the content restrictions database 360 (FIG. 3). In this table, the value 7 corresponds to the path to an image file for a particular company's product. The content control module 100 (FIG. 1) then requires that this image be displayed for the duration of the priority event.

The aforementioned trigger PDU 800 can be implemented in various different ways. The term PDU is used to describe an entity independent of any particular protocol. Thereby, the trigger PDU 800 may be implemented in a manner as described above, in a proprietary manner, or in accordance with a standardized protocol. In a non-limiting example, the trigger PDU 800 could be implemented according to one of the well-known Advanced Television Enhancement Forum (ATVEF) standards. In one implementation, the trigger PDU 800 could be provided according to the ATVEF transport type A. Under transport type A, the trigger PDU 800 would be a standardized broadcast data trigger without resource delivery. Alternatively, under ATVEF transport type B, the trigger PDU 800 could be implemented in manner so as to supply resource streams such as the location of desired media content. The trigger PDU 800 can be implemented in various ways according to different specific protocol requirements, however the trigger PDU 800 is understood to be independent of these specific protocol requirements.

FIG. 8B is a diagram depicting an example transport stream. The transport stream 860 depicted in FIG. 8B consists of packets containing data relating to the numerous services and applications provided by the subscriber television system 110 (FIG. 1). FIG. 8B shows an example of two of these packets. The payload portion 862 of the packet contains the raw data for the services and applications, and the header portion 861 of the packet contains operation, administration, maintenance, and provisioning (OAM&P) information for the subscriber television system 110 (FIG. 1). In one implementation, the header portion 861 contains, among other things, the trigger PDU 800. The trigger PDU 800 contains, as described above, information for the content control module 100 (FIG. 1) to restrict the display of media content. In the implementation depicted in FIG. 8B, the trigger PDU 800 is simply inserted into the header 861 along with the other control information for the subscriber television system 110 (FIG. 1). The trigger PDU 800 could occupy a designated portion in the header 861 or simply be inserted into the header 861 when necessary. In a manner similar to the implementations described in relation to FIG. 8A, the trigger PDU 800 is received by the content control module 100 (FIG. 1) and indicates a priority event. In a simplistic implementation, the trigger PDU 800 could simply be a asserted bit in the header 862. In another implementation, among others, the trigger PDU 800 could be a unique bit sequence utilized by the content control module 100 (FIG. 1) to execute a desired content restriction.

The transport streams depicted in FIG. 8A and 8B are merely examples of the various different ways in which the trigger PDU 800 could be provided to the content control module 100 (FIG. 1). It should be apparent to one of ordinary skill in the art that in some implementations the trigger PDU 800 would not even be necessary. Furthermore, the trigger PDU 800 could be incorporated into the actual restricted media content. In a non-limiting example, the data provided for the media content for which restrictions are desired could carry the trigger PDU 800.

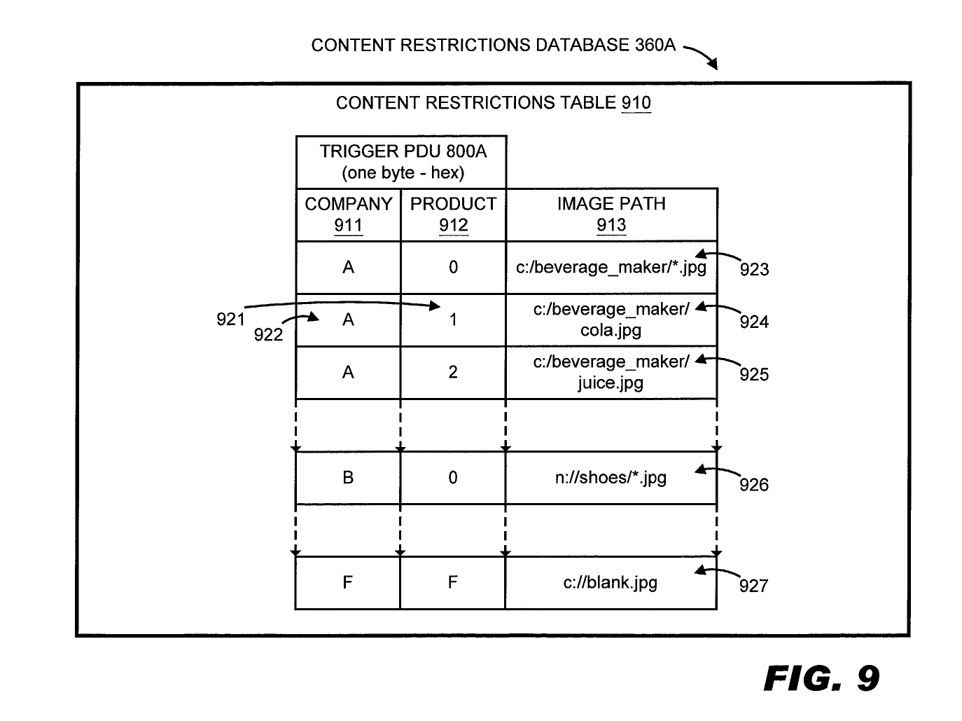

FIG. 9 is a diagram depicting an example content restrictions storage method. The content restrictions storage method shown in FIG. 9 is an example implementation of a portion of a content restrictions database 360A. In the implementation depicted in FIG. 9, the content restrictions database 360A contains, among other things, a content restrictions table 910. This content restrictions table 910 contains a listing of trigger PDUs 800A and their associated restricted images. As described in an aforementioned implementation, the trigger PDU 800A can be configured as a unique bit sequence. This unique bit sequence is interpreted by the content control module 100 (FIG. 1) and a desired advertisement banner image is determined. In one implementation, the trigger PDU 800A is one byte provided to the content control module 100 (FIG. 1). The content control module 100 (FIG. 1) references this byte against the content restrictions table 910. The entry in the content restrictions table 910 that matches the byte value of the trigger PDU 800A determines the restricted image that is to be displayed.

In the implementation depicted in FIG. 9, the content restrictions table 910 contains a listing of the possible trigger PDU 800A byte values in hexadecimal format. In a non-limiting example, the first nibble of the trigger PDU 800A byte, assuming a little-endian format, is a reference to a particular company. The second nibble is a reference to a particular product of the company referenced in the first nibble. One entry in the content restrictions table 910 is for the trigger PDU 800A value of “A1”. The first nibble “A” 922 is a reference to a particular company 911. The second nibble “1” 921 is a reference to a product 912 of company 911. In an non-limiting example, if the trigger PDU 800A had a value of “A1”, the content control module 100 (FIG. 1) would reference the content restrictions table 910 and determine the image path of the desired advertisement banner image to be “c://beverage_maker/cola.jpg” 924. Therefore, the content control module 100 (FIG. 1) would require the image “c://beverage_maker/cola.jpg” 924 to be displayed when the priority event corresponding to trigger PDU 800A value “A1” occurred. The above occurrence would take place, in a non-limiting example, when a commercial for the company “Beverage Maker” was being displayed, and it was desired that a image of “Beverage Maker's” product “Cola” be displayed in an advertisement banner at the same time.

In the case of the implementation shown in FIG. 9, when the second nibble is equal to zero, the reference is for any product by that particular company. The image path 913 for the trigger PDU 800A value “A0” is equal to “c://beverage_maker/*.jpg” 923. The wildcard in the path indicates to the content control module 100 (FIG. 1) that the only restriction associated with trigger PDU 800A value “A0” is that some image associated with the company “Beverage Maker” be displayed in association with this priority event.

The image path 913 for the trigger PDU 800A value “B0” is “n://shoes/*.jpg” 926. This image path indicates to the content control module 100 (FIG. 1) that the necessary image file is not stored in memory local to the client device, such as “c://”, but is located elsewhere in the subscriber television system 110 (FIG. 1). In one implementation the “n://shoes/*.jpg” 926 could correspond to a memory device located in the STS headend 120 (FIG. 1) or in the external network 190 (FIG. 1).

It should be apparent to one of ordinary skill in the art that the content restrictions database 360A could be stored in various locations. The content restrictions database 360A could be stored in the client device 140A (FIG. 1), the STS Headend 120A (FIG. 1), or in a device in the external network 190 (FIG. 1). In addition, the content restrictions database 360A could be partioned and stored in different areas. In a non limiting example, the content restrictions table 910 could be stored in the client device 140A (FIG. 1A) and the necessary media content could be stored in the STS headend 120 (FIG. 1). The content restrictions table 910 is just one of many content restrictions tables that could be stored in the content restrictions database 360A. Examples of additional content restrictions tables include, among others, tables for specific applications, including, among others, a browser application and a video on demand application.

In one implementation, the content restrictions table 910 is statically configured by an administrator accessing the administrative content control module 170 (FIG. 1) through the administrative user interface 190 (FIG. 1). In this implementation the adminstrator could use the administrative user interface 190 (FIG. 1) to modify the different trigger PDU 800A values and their associated image paths 913.

In an alternate implementation, the content restrictions table 910 could be dynamically updated from a remote location. In a non-limiting example of this implementation, the administrative content control module 170 could be accessed from a location in the external network 190 (FIG. 1), such as from a television studio. Therefore, an administrator at a particular television studio could access the administrative content control module 170 and configure content restrictions for the commercials associated with that television studio's broadcast channels. That particular television studio could also configure devices to dynamically update the content restrictions associated with that television studio's broadcast channels. A television studio might not only configure content restrictions through the administrative content control module 170 (FIG. 1), but it might also provide the actual media content to be displayed in association with the desired content restrictions. As previously mentioned, the image files to be displayed in the advertisement banners might be located at a device in the external network 190 (FIG. 1), such as, for example, a server at a television studio. In addition, it would be possible in some implementations to provide the image file in the same transport stream used to broadcast a television studio's channels.

In an example embodiment, the trigger PDU is implemented in accordance with a standardized number sequence. The standardized numbering sequence might be implemented in a manner similar to that of the U.S. Standard Industrial Classification (SIC) system or the North American Industry Classification System (NAICS). In this manner, the unique bit sequence for the trigger PDU is an established and standardized number where certain portions of the number correspond to certain designations. The trigger PDU is not bound to any particular subscriber television system. In a non-limiting example, the number sequence might consist of 20 digits where a portion of the digits designate a particular industry, the other portion designate a particular company, and the other portion designate a particular product of that company. Thereby, the trigger PDU would designate a restriction for something as general as an industry or as specific as a product. Inclusive content restrictions could be designated per industry, company, and product. Exclusive content restrictions could be designated by simply requiring a media content corresponding to a different industry code to be displayed. This hierarchy of industry, company, and product is provided as merely an example hierarchy. This hierarchy could contain many more levels of specification regarding areas of industries, different divisions within companies, and different divisions of product groupings. Thereby, the content control module 100 (FIG. 1) could be configured to use a given hierarchy to effectuate a best case, promote a desired product, to worst case, do not promote any competitors, content restriction implementation.

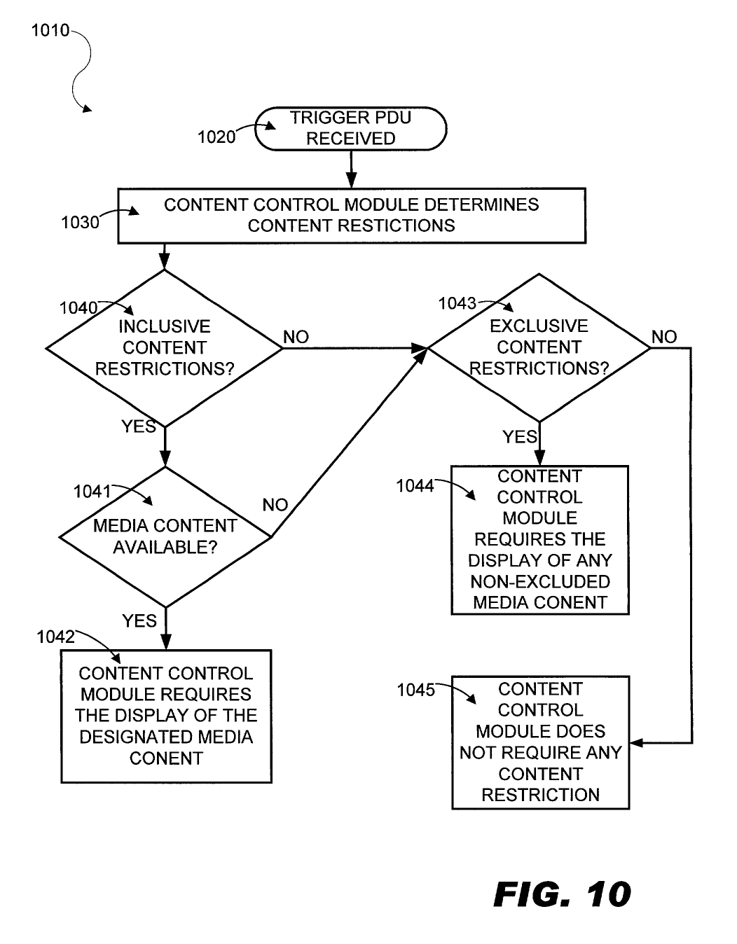

FIG. 10 is a flowchart of the process of determining the necessary actions by the content control module 100 (FIG. 1) when a trigger PDU is received. The aforementioned trigger PDU provides an indication to the content control module 100 (FIG. 1) that a priority event is taking place. As described above, a priority event is any display by the subscriber television system 110 (FIG. 1) for which content restrictions have been designated. The flowchart of FIG. 10 depicts the process 1010 beginning when trigger PDU is received 1020. Once the trigger PDU is received, the content control module 100 (FIG. 1) determines content restrictions 1030. Next, the content control module 100 (FIG. 1) determines if inclusive content restrictions 1040 have been provided. Inclusive restrictions are those that require a particular media content, usually associated with the same company, to be displayed. If inclusive content restrictions have been provided, then the content control module 100 (FIG. 1) determines if the desired media content is available 1041. If the desired media content is available, then the content control module 100 (FIG. 1) requires the display of this designated media content 1042. In a non-limiting example, the Soda Company has requested an inclusive content restriction requiring the display of the Soda Company's commercial to be accompanied by the display of an image of Soda Company's product in an advertisement banner. When the Soda Company's commercial airs, a trigger PDU is received, and the content control module 100 (FIG. 1) determines the required inclusive content restrictions. Then the content control module 100 (FIG. 1) finds the designated image of Soda Company's product and requires the display of that image in the advertisement banner to be simultaneous with the display of the Soda Company's commercial.

If no inclusive content restrictions have been provided 1040 or if the media content is not available 1041, then the content control module 100 (FIG. 1) determines if exclusive content restrictions have been provided 1043. Exclusive content restrictions require that certain media content, usually associated with a competitor, not be displayed. If exclusive content restrictions have been provided, then the content control module requires the display of any non-excluded media content 1044. A non-limiting example of this might be when a commercial for Soda Company is broadcast, no media content for companies competing with Soda Company are displayed. If no inclusive content restrictions 1040 or exclusive content restrictions 1043 have been provided, then the content control module 100 (FIG. 1) may not require any content restrictions 1045 on the media content that is displayed. In a non-limiting example, if a commercial is displayed and no content restrictions have been specified for that commercial, then the no restrictions will be placed upon the display of secondary media content.

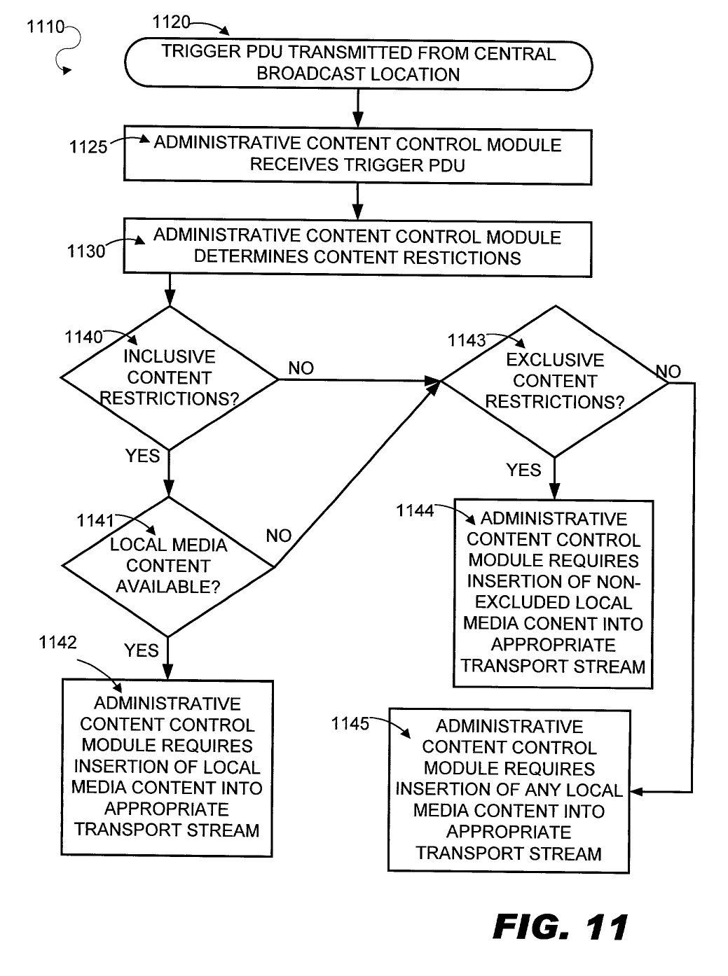

FIG. 11 is a flowchart of the process of determining the necessary actions by the administrative content control module 170 (FIG. 1) when a trigger PDU is received from a central broadcast location. A central broadcast location is the point of origination for a particular transport stream, examples including, among others, a television studio, a network distribution site, or a satellite broadcast network. The first step in the process 1110 depicted in FIG. 11 involves the central broadcast location inserting a trigger PDU 1120 into a transport stream. This trigger PDU could indicate a variety of different things to the subscriber television system 110 (FIG. 1), such as for example, a break in the transport stream enabling the insertion of local media content. A non-limiting example of local media content is a commercial, an image, a video stream, or an audio stream. Next, the administrative content control module 170 (FIG. 1) receives the trigger PDU 1125, and then 1o the administrative content control module 170 (FIG. 1) determines the content restrictions 1130. In a non-limiting example, the trigger PDU might not only indicate an available insertion area in the transport stream for an insertion of local media content but also indicate certain content restrictions associated with this available insertion area. The administrative content control module 170 (FIG. 1) may first determine whether there are inclusive content restrictions 1140. If there are inclusive content restrictions, then the administrative content control module 170 (FIG. 1) may determine if the designated local media content is available 1141. If the administrative content control module 170 (FIG. 1) determines the necessary local media content is available, then the administrative content control module 170 (FIG. 1) requires the insertion of the local media content into the appropriate transport stream 1142.

A non-limiting example of the process described above can be illustrated by considering a television studio F distributing a transport stream for its channel G. Television studio F intentionally leaves available insertion areas in the transport stream of channel G to allow a subscriber television system 110 (FIG. 1) to insert local commercials. In addition, Channel G is displaying a sports event sponsored by a particular group of companies. Therefore, television studio F would like to restrict the local commercials inserted by the subscriber television system 110 (FIG. 1) to be associated with the sponsored companies. Television studio F can accomplish this by configuring the trigger PDU with certain inclusive content restrictions. These inclusive content restrictions may indicate to the administrative content control module 170 (FIG. 1) which local media content is acceptable for input into the transport stream. In a non-limiting example, the sponsor of the program being broadcast on channel G is the Car Manufacturer. Therefore, when the administrative content control module 170 (FIG. 1) receives the trigger PDU, it can determine from the inclusive content restrictions that any inserted local commercials be for companies associated with the Car Manufacturer. The administrative content control module 170 (FIG. 1) might then require insertion of a local commercial for a local dealership of the Car Manufacturer.

If the administrative content control module 170 (FIG. 1) determines that either there are no inclusive content restrictions 1140 or the local media content is not available 1141, then it may be determined as to whether there are exclusive content restrictions 1143. If there are exclusive content restrictions, then the administrative content control module 170 (FIG. 1) requires the insertion of non-excluded local media content into the appropriate transport stream 1144. Consider the above example where the Car Manufacturer sponsored the program on channel G. Rather than requiring the insertion of a local commercial affiliated with the Car Manufacturer, exclusive content restrictions could be provided in the trigger PDU to require the insertion of any local commercial not affiliated with one of the Car Manufacturer's competitors.

In the case where no inclusive content restrictions or exclusive content restrictions have been provided, then the administrative content control module 170 (FIG. 1) allows the insertion of any local media content into the appropriate transport stream 1145. In a non-limiting example, the television studio K sends its transport stream for channel L to a subscriber television system 110 (FIG. 1) with an intentional available insertion area in the transport stream for the insertion of any local commercial. Thereby, the administrative content control module 170 (FIG. 1) can be notified of this available insertion area by the trigger PDU and insert any local commercial into the broadcast to be displayed to a subscriber.

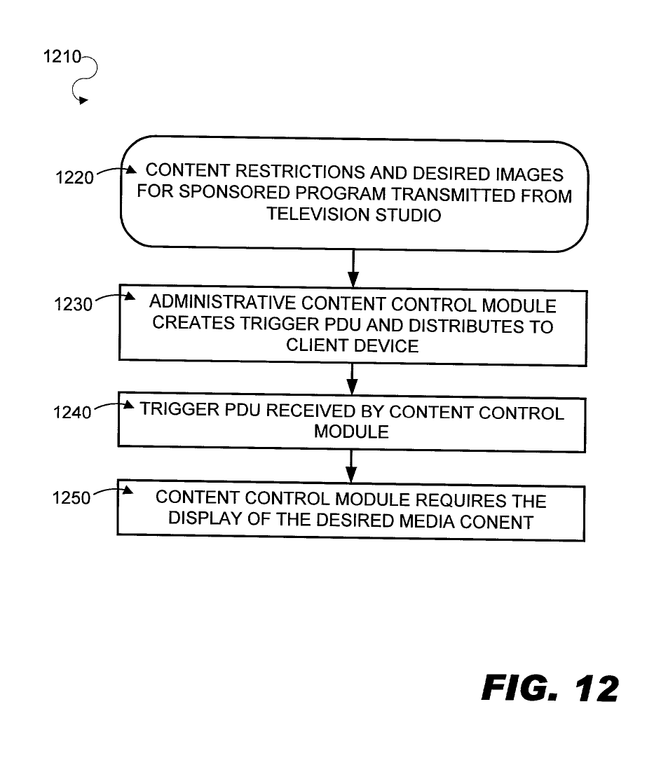

FIG. 12 is a flowchart of the process of determining the necessary actions when content restrictions are received from a television studio. In the process 1210 depicted in FIG. 12, a television studio requests the application of certain content restrictions for a particular sponsored program. A sponsored program may be sponsored by a group of companies, and the television studio may desire the media content displayed to a subscriber viewing this sponsored program to be associated with a member of the sponsoring group of companies. The first step in the process, involves a transmission of the content restrictions and desired media content from the television studio 1220. This transmission could occur, for example, from a server in the television studio located in the external network 190 (FIG. 1) to the administrative control module 170 (FIG. 1). Once the transmission has been made, the administrative control module 170 (FIG. 1) creates an appropriate trigger PDU and distributes it to a client device 1230. In one implementation, this trigger PDU contains an indication of a priority event, the content restrictions, and the desired media contend needed to satisfy these content restrictions. The content control module then receives the trigger PDU 1240. Using the trigger PDU, the content control module is able to determine the timing of the priority event, the necessary content restrictions, and the associated desired media content. Therefore, the content control module requires the display of this desired media content.

In a non-limiting example, a television studio requests certain content restrictions for a sponsored event such as, for example, an Olympic sports broadcast. This Olympic sports broadcast is sponsored by Company R, S, and T. Therefore, if any additional promotional lo media content is displayed to a subscriber viewing the Olympic sports broadcast, then this promotional media content should be associated with Company R, S, or T. To effectuate these content restrictions, the television studio sends a transmission from one of its devices in the external network 190 (FIG. 1) to the administrative control module 170 (FIG. 1) containing the content restrictions and desired media content necessary for these content restrictions. The administrative control module 170 (FIG. 1) receives this information and packages it into a trigger PDU and distributes that trigger PDU to the client device 140A. (FIG. 1). The content control module 100 (FIG. 1) in the client device 140A (FIG. 1) receives the trigger PDU and executes its restrictions. Therefore, the content control module 100 (FIG. 1) may require the display of a desired media content, an image associated with Company R, S, or T, if an advertisement banner is displayed to a subscriber viewing the Olympic sports broadcast.

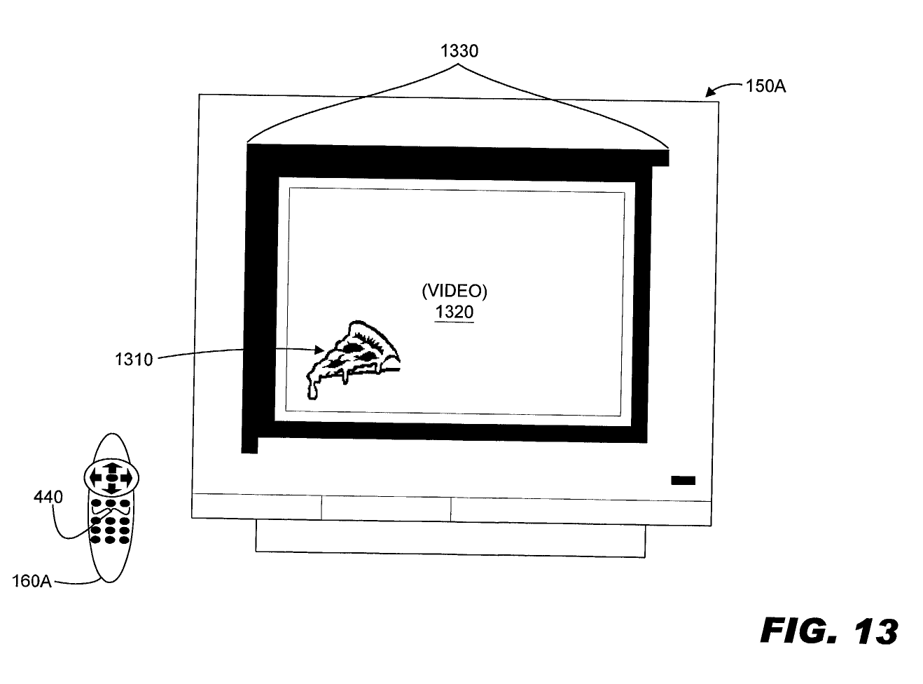

FIG. 13 is a diagram depicting a screen display in accordance with one embodiment of the present invention. The screen display 1330 depicted in FIG. 13 is shown as it would appear on display device 150A. Display device 150A is a standard television and represents one non-limiting example of a display device. The display device 150A is displaying the video 1320 to a subscriber. In the implementation depicted in FIG. 13, the screen display 1330 includes not only the media content of video 1320 but also includes an advertisement icon 1310. The advertisement icon 1310 is another example of the variety of media content that the subscriber television system 100 (FIG. 1) can provide to be displayed to the subscriber. An advertisement icon can be an unlimited variety of images. In some implementations, these advertisement icons are referred to as Shoshkeles™ advertisements. As one reasonably skilled in the art of the present invention would recognize, such ads can typically be browser driven, platform agnostic, sound enabled, free moving forms that do not require plug-ins or cause discernable download for a user. The client control module 100 (FIG. 1) enables a subscriber television system 110 (FIG. 1) to incorporate these advertisements icons into a video stream at certain specific moments in the video stream.

The advertisement icon 1310 is a non-limiting example of an advertisement icon depicting a slice of pizza. The content control module 100 (FIG. 1) in configured such that it controls the display of advertisement icon 1310 in association with priority events occurring in video 1320. In a non-limiting example, the video 1320 would be a video stream of a movie. The content control module 100 (FIG. 1) could require the advertisement icon 1310 to be displayed simultaneously with a scene in the movie where the characters are eating pizza. The advertisement icon 1310 might be a slice of pizza that a movie character is holding in the movie character's hand, which morphs into an icon of a pizza slice that floats to the bottom of the screen, as depicted in screen display 1330. The advertisement icon 1310 could be associated with a particular pizza company and promote the purchase of pizza from this particular pizza company.

Furthermore, the subscriber television system 110 (FIG. 1) could allow the subscriber to enter an immediate purchase for an item associated with the advertisement icon depicted in the screen display. In one implementation, the subscriber could purchase an item associated with the advertisement icon by selecting an appropriate function key 440 on the client command device 160A. The subscriber television system 110 (FIG. 1) could be enabled to execute the purchase of the item associated with the advertisement icon simply by single press of the appropriate function key 440 on the client command device 160A. In a non-limiting example, the client device 140A (FIG. 1) could keep a record of all the necessary subscriber purchase information. In this example, when the advertisement icon 1310 was displayed on the screen display 1330 in association with a pizza eating scene in the movie in video 1320, the subscriber could press the appropriate function key 440 on the client command device 160A and have a pizza delivered to the subscriber's house immediately.

It will be apparent to one of ordinary skill in the art that the advertisement icon could be used for a variety of different promotional measures. In an alternate non-limiting example, the advertisement icon could be pair of sunglasses worn by the star of a movie which become a selectable advertisement icon for purchase at the bottom of the screen during the scene where the star is wearing the sunglasses. In any implementation, the content control module 100 (FIG. 1) can enable the subscriber television system 110 (FIG. 1) to display these advertisement icons or any other media content at the same time as the desired priority event.

The content control module of the present invention can be implemented in hardware, software, firmware, or a combination thereof. In addition, the content control module can be implemented in a distributed fashion in more than one device in the system. In the preferred embodiment(s), the content control module is implemented in software or firmware that is stored in a memory and that is executed by a suitable instruction execution system. If implemented in hardware, as in an alternative embodiment, content control module can be implemented with any combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The transaction configuration module, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly any “preferred embodiments”, are merely possible examples, among others, of the implementations, setting forth a clear understanding of the principles of the inventions. Many variations and modifications may be made to the above-described embodiments of the invention without departing substantially from the principles of the invention. All such modifications and variations are intended to be included herein within the scope of the disclosure and present invention and protected by the following claims.

Therefore, having thus described the invention, at least the following is claimed:

1. A method in a subscriber television system (STS), the method comprising the steps of:
providing a plurality of media content instances to be displayed to a subscriber;
providing at least one trigger synchronized with a first media content instance of the plurality of media content intances; and
enabling at least one content restriction responsive to a reception of the at least one trigger.

2. The method of claim 1, wherein the at least one content restriction requires a second media content instance of the plurality of media content instances to be displayed for a time period.

3. The method of claim 2, wherein the time period is equal to the length of display of the first media content instance of the plurality of media content instances, and wherein the second media content instance of the plurality of media content instances is displayed simultaneously with the first media content instance of the plurality of media content instances.

4. The method of claim 1, wherein the at least one content restriction requires a second media content instance of the plurality of media content instances to be excluded from display for a time period.

5. The method of claim 4, wherein the time period is equal to the length of the display of the first media content instance of the plurality of media content instances, and wherein the second media content instance of the plurality of media content instances is excluded from display during the display of the first media content instance of the plurality of media content instances.

6. The method of claim 1, further comprising the step of:
implementing the at least one content restriction to be a hierarchy of at least one inclusive content restriction and at least one exclusive content restriction;
enabling the at least one inclusive content restriction to require the display, if available, of a second media content instance of the plurality of media content instances designated by the at least one inclusive content restriction; and
enabling the at least one exclusive content restriction if the second media content instance of the plurality of media content instances is not available, the at least one exclusive content restriction allowing the display of any of the plurality of media content instances not excluded by the exclusive content restriction.

7. The method of claim 1, wherein the at least one trigger includes the at least one content restriction.

8. The method of claim 1, wherein the at least one trigger comprises information indicating the location of at least one media content instance needed to satisfy the at least one content restriction.

9. The method of claim 1, wherein the at least one trigger comprises at least one media content instance needed to satisfy the at least one content restriction.

10. A method in a subscriber television system (STS), the method comprising the steps of:
providing a plurality of media content instances to be displayed to a subscriber by a client device;
providing at least one trigger synchronized with a first media content instance of the plurality of media content instances, the at least one trigger comprising at least one unique identifier;
enabling at least one content control module in the client device, the at least one content control module comprising a database of a plurality of values for a plurality of the at least one unique identifier, the plurality of values being individually matched with a corresponding content restriction;
receiving the at least one trigger at the client device;
interpreting a value of the at least one trigger by the content control module; and
enabling the content control module to reference the database with the value and determine at least one enabled content restriction.

11. The method of claim 10, wherein the client device displays a screen display comprising an application interface, an advertisement banner, and a video stream, the video stream displaying a first media content instance of the plurality of media content instances, the first media content instance of the plurality of media content instances being a commercial.

12. The method of claim 11, wherein the enabled content restriction is an inclusive content restriction, the inclusive content restriction requiring the display of a second media content instance of the plurality of media content instances in the advertisement banner.

13. The method of claim 12, wherein the second media content instance of the plurality of media content instances is associated with a funding entity of the commercial.

14. The method of claim 11, wherein the enabled content restriction is an exclusive content restriction, the exclusive content restriction allowing the display of any of the plurality of media content instances in the advertisement banner not excluded by the exclusive content restriction.

15. The method of claim 14, wherein at least one of the plurality of media content instances excluded by the exclusive content restriction is media content associated with a competitor of a funding entity of the commercial.

16. The method of claim I 1, wherein the enabled content restriction is an inclusive/exclusive combination content restriction, and wherein the inclusive/exclusive combination content restriction requires the display of a second media content instance of the plurality of media content instances in the advertisement banner if available, the second media content instance of the plurality of media content instances being associated with a funding entity of the commercial, if the second of the media content is not available, then the inclusive/exclusive combination content restriction requires the display of a third of the plurality of media content instances in the advertisement banner, the third of the plurality of media content instances being any media content not associated with a competitor of a funding entity of the commercial.

17. A method in a subscriber television system (STS), the method comprising the steps of:
inserting, within an available insertion area in at least one transport stream, at least one trigger having at least one content restriction; and
distributing the at least one transport stream with the at least one trigger to a plurality of client devices.

18. The method of claim 17, wherein the at least one content restriction is an inclusive content restriction requiring the insertion of at least one designated media content instance, and wherein the designated media content instance is inserted into the available insertion area in the at least one transport stream.

19. The method of claim 18, wherein the at least one designated media content instance is a local commercial.

20. The method of claim 17, wherein the at least one content restriction is an exclusive content restriction requiring the exclusion of at least one designated media content instance.

21. A method in a subscriber television system (STS), the method comprising the steps of:
providing a plurality of media content instances to be displayed to a subscriber, a first media content instance of the plurality of media content instances being a video stream and a second media content instance of the plurality of media content instances being an advertisement;
providing at least one trigger synchronized with a priority event in the video stream; and
enabling the advertisement to be displayed simultaneously with the priority event in the video stream.

22. The method of claim 21, wherein the advertisement is selectable by the subscriber.

23. The method of claim 21, wherein the advertisement is an image of a scene item, and wherein the priority event is a scene displayed in the video stream where the scene item is represented.

24. A system in a subscriber television system (STS), the system comprising:
a memory for storing logic;
a processor for executing the logic stored in memory;
logic configured to provide a plurality of media content instances to be displayed to a subscriber;
logic configured to provide at least one trigger synchronized with a first media content instance of the plurality of media content instances; and
logic configured to enable at least one content restriction responsive to a reception of the at least one trigger.

25. The system of claim 24, wherein the least one content restriction requires a second media content instance of the plurality of media content instances to be displayed for a time period.

26. The system of claim 25, wherein the time period is equal to the length of the display of the first media content instance of the plurality of media content instances, and 3 wherein the second media content instance of the plurality of media content instances is displayed simultaneously with the first media content instance of the plurality of media content instances.

27. The system of claim 24, wherein the least one content restriction requires a second media content instance of the plurality of media content instances to be excluded from display for a time period.

28. The system of claim 27, wherein the time period is equal to the length of the display of the first media content instance of the plurality of media content instances, and wherein the second media content instance of the plurality of media content instances is excluded from display during the display of the first media content instance of the plurality of media content instances.

29. The system of claim 24, wherein the trigger comprises the at least one content restriction.

30. The system of claim 24, wherein the trigger comprises at least one media content needed to satisfy the at least one content restriction.

31. A system in a subscriber television system (STS) client device, the system comprising:
a memory for storing logic in the STS client device;
a processor for executing the logic stored in memory in the STS client device;
logic configured to provide a plurality of media content instances to be displayed to a subscriber;
logic configured to provide at least one trigger synchronized with a first media content instance of the plurality of media content instances; and
logic configured to enable at least one content restriction responsive to a reception of the at least one trigger.

32. The system of claim 31, wherein the least one content restriction requires a second media content instance of the plurality of media content instances to be displayed for a time period.

33. The system of claim 32, wherein the time period is equal to the length of the display of the first media content instance of the plurality of media content instances, and wherein the second media content instance of the plurality of media content instances is displayed simultaneously with the first media content instance of the plurality of media content instances.

34. A system in a subscriber television system (STS) headend device, the system comprising:
a memory for storing logic in the STS headend device;
a processor for executing the logic stored in memory in the STS headend device;
logic configured to provide a plurality of media content instances to be displayed to a subscriber;
logic configured to provide at least one trigger synchronized with a first media content instance of the plurality of media content instances; and
logic configured to enable at least one content restriction responsive to a reception of the at least one trigger.

35. The system of claim 34, wherein the least one content restriction requires a second media content instance of the plurality of media content instances to be displayed for a time period.

36. The system of claim 35, wherein the time period is equal to the length of the display of the first media content instance of the plurality of media content instances, and wherein the second media content instance of the plurality of media content instances is displayed simultaneously with the first media content instance of the plurality of media content instances.

37. A system in a subscriber television system (STS) headend, the system comprising:
a memory for storing logic in the STS headend;
a processor for executing the logic stored in memory in the STS headend;
logic configured to allow the STS headend to receive and distribute at least one transport stream to a plurality of client devices, the STS headend comprising an administrative content control module; and
logic configured to enable at least one trigger to be synchronized with an available insertion area in the transport stream, the at least one trigger comprising at least one content restriction.

38. The system of claim 37, wherein the at least one content restriction is an inclusive content restriction requiring the insertion of at least one designated media content, and wherein the administrative content control module allows the insertion of the least one designated media content into the available insertion area in the transport stream.
